(19) United States
(12) Patent Application Publication
(10) Pub. No.: US 2008/0265458 A1
(43) Pub. Date: Oct. 30, 2008

(54) Method for forming an over-molded product

(76) Inventor: Keith Hershner, Glen Rock, PA (US)

Correspondence Address: AMSTER, ROTHSTEIN & EBENSTEIN LLP, 90 PARK AVENUE, NEW YORK, NY, 10016, US

(21) Appl. No.: 11/789,200

(22) Filed: Apr. 24, 2007

(51) Int. Cl. B28B 7/00

(52) U.S. Cl. 264/255; 425/472

(57) ABSTRACT

A method of molding a second part onto a first part to form a molded product including placing a blank between a first mold half and a second mold half of a mold, where the first mold half includes at least one cavity, trimming the blank to form the first part, and injecting molten resin into the at least one cavity of the first mold half to mold the second part onto the first part.

### TECHNICAL FIELD

The present invention is related to molding processes, and more particularly to over-molding processes involving a trimming step.

### BACKGROUND

In molding operations, a base part on which another part is molded often needs to be trimmed to remove the base part from a blank or to simply change the size and/or shape of the base part. In the past, this has required a separate trimming operation, either prior to or after the actual molding step. For example, in the production of tympanic thermometer prove tip covers, structural elements may be overmolded onto a base of flexible polyethylene. A secondary trimming operation is required to remove the base from the web blank. This separate trimming step adds to the overall cost and reduces the yield of the molding process.

Accordingly, there is a need for a molding process in which a part is molded onto a base element, where a trimming step for removing the base element from a blank, separate from the actual mold stroke cycle, is not required.

### SUMMARY OF THE INVENTION

A method of molding a second part onto a first part to form a molded product according to an exemplary embodiment of the present invention includes placing a blank between a first mold half and a second mold half of a mold, where the first mold half includes at least one cavity, trimming the blank to form the first part, and injecting molten resin into the at least one cavity of the first mold half to mold the second part onto the first part.

In at least one embodiment, the blank is a flexible film, and the method further comprises a step of generating tension in the flexible film.

In at least one embodiment, the molded product is a tympanic thermometer probe tip cover, and the trimming step comprises trimming the flexible film to form a disc-shaped base element of the probe tip cover as the first part.

In at least one embodiment, the second part includes inner and outer rings of the probe tip cover.

In at least one embodiment, the first mold half comprises two cavities that correspond to the inner and outer rings of the probe tip cover.

In at least one embodiment, the flexible film is made of polyethylene.

In at least one embodiment, the molten resin is high density polyethylene.

In at least one embodiment, the molten resin includes polyesters, nylons, urethanes, silicone, polyvinyl chloride, neoprene, thermoplastic rubber, Tyvek® materials, polypropylene and/or polyethylene-terephthalate.

A mold according to an exemplary embodiment of the present invention for molding a second part onto a first part to form a molded product during a molding operation includes a first mold half having at least one cavity that receives molten resin to form the second part, a second mold half, and a trimming element for trimming the first part during the molding operation.

In at least one embodiment, the trimming element is disposed around the first mold half and is slidable relative to the first mold half to trim the first part.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a plan view of a probe tip cover formed by the process according to an exemplary embodiment of the present invention;

FIG. 2 is a cross-sectional view taken along the line 2-2 in FIG. 1;

FIG. 3 is a cross-sectional view of a mold used in a molding process according to an exemplary embodiment of the present invention;

FIG. 4 is a representative drawing of a molding process line according to an exemplary embodiment of the present invention;

FIG. 5 is a cross sectional view showing a molding process according to an exemplary embodiment of the present invention; and

FIG. 6 is a partial plan view of a probe tip cover formed on a blank by the molding process according to an exemplary embodiment of the present invention.

### DETAILED DESCRIPTION OF PREFERRED EMBODIMENTS

In the method according to various exemplary embodiments of the present invention, a first part is trimmed from a blank during a molding process in which a second part is overmolded onto the first part. According to the process, during a single stroke of the mold, the second part is overmolded while the first part is simultaneously trimmed. The simultaneous trimming and molding steps of the present invention provides improved alignment between the first and second parts, and offers a higher yield in the overall molding operation since less process steps are required. The present invention is described within the context of high density polyethylene (HDPE) overmolded onto a strip of flexible polyethylene, particularly to form a probe cover tip. However, it should be appreciated that the present invention is not intended to be limited to any particular materials or final product, and other materials, such as, for example, glass metal and ceramic raw materials, may be used in the process to form any other desired final or intermediate products. For example, the inventive process may be used to form a sterile barrier for any type of medical device, such as a flexible cover for an endoscope. Other flexible materials besides HDPE may be used, such as, for example, polyesters, nylons, urethanes, silicone, polyvinyl chloride, neoprene, thermoplastic rubber, Tyvek® materials, polypropylene and polyethylene-terephthalate, to name a few. Further, although the process shown and described herein is a horizontal molding operation, it should be appreciated that a vertical molding operating is also applicable.

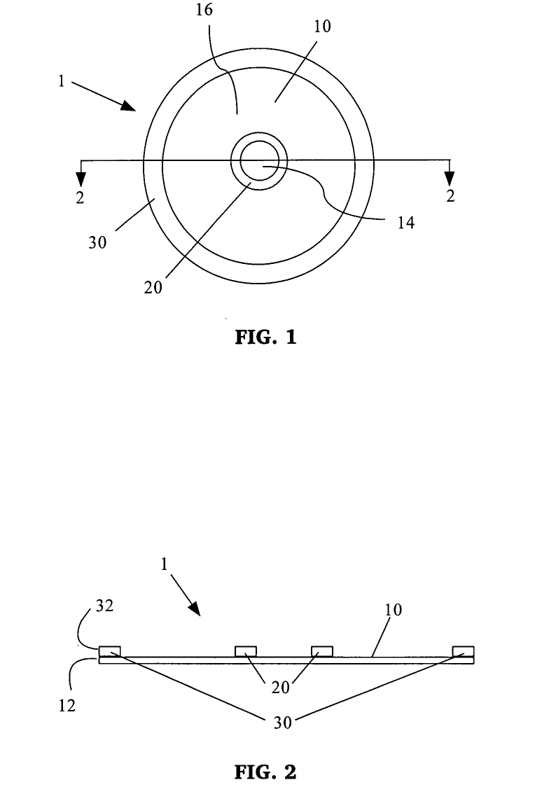

FIG. 1 is a plan view of a probe tip cover, generally designated by reference number 1, formed using the process according to an exemplary embodiment of the present invention, and FIG. 2 is a cross-sectional view taken along the line 2-2 in FIG. 1 of the probe tip cover 1. The probe tip cover 1 includes a generally disc-shaped base element 10, an inner ring 20, and a concentric outer ring 30. The outer diameter edge 32 of the outer ring 30 is preferably aligned with the outer diameter edge 12 of the base element 10. The inner ring 20 defines an inner portion 14 of the base element 10, and the inner and outer rings 20, 30 define an outer portion 16 of the base element 10. In use, the inner portion 14 of the base element 10 is disposed over the flat end of the probe tip of a tympanic thermometer, and the outer portion 16 of the base element 10 is disposed over the sides of the probe tip.

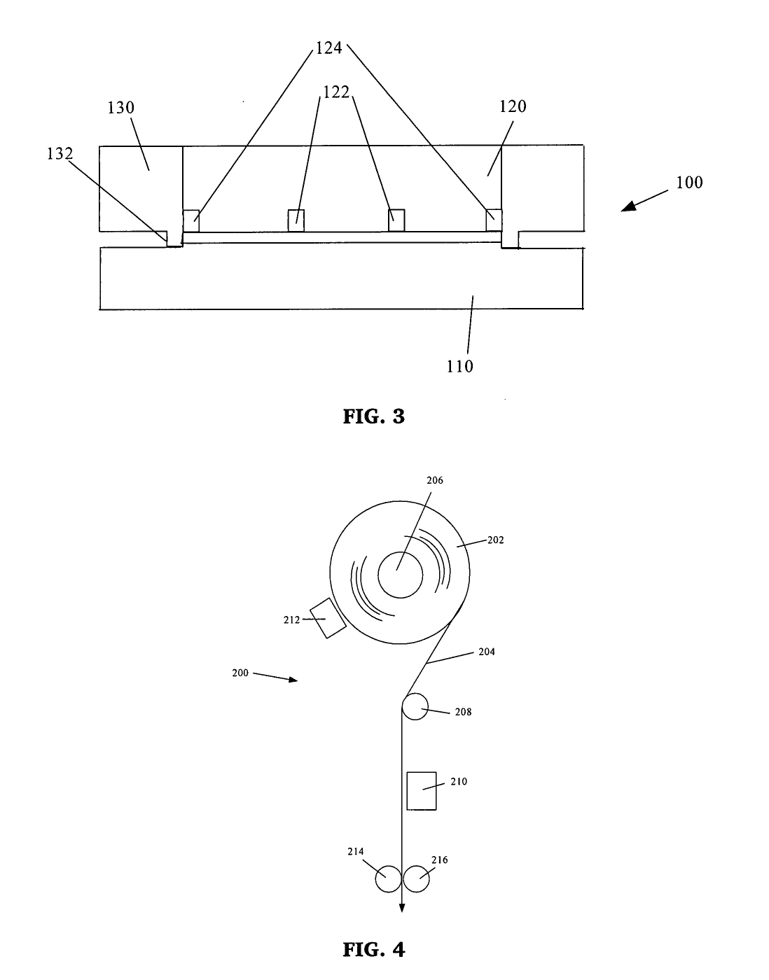

FIG. 3 is a cross sectional view of a mold, generally designated by reference number 100, used in the process according to an exemplary embodiment of the present invention. The mold 100 includes a lower mold half 110, an upper mold half 120 and a cutting ring 130 disposed around and slidable vertically relative to the upper mold half 120. The upper mold half 120 includes one or more cavities that receive molten mold material to form the final product. In the present embodiment, the upper mold half 120 includes an inner annular cavity 122 and a concentric outer annular cavity 124, which receive molten material to form the inner and outer rings 20, 30, respectively, of the probe tip cover 1. The cutting ring 130 includes a downwardly extending annular flange 132 that functions as a cutting member during the molding operation.

During the molding operation, the upper mold half 120 is moved downwardly over the lower mold half 110, and the cutting ring 130 is slid downwards relative to the upper mold half 120 until the bottom surface of the annular flange 132 contacts the top surface of the lower mold half 110. Thus, a portion of the inner diameter of the cutting ring 130 forms the outer wall of the second annular cavity 124 during the molding operation. Further, as explained in more detail below, the annular flange 132 trims a blank in the mold 100 to form the annular base member 10 of the probe cover 1. Preferably, the upper mold half 120 is movable, while the lower mold half 110 is held stationary.

FIG. 4 is a representative drawing of a molding process line, generally designated by reference number 200, according to an exemplary embodiment of the present invention used to form the probe tip cover 1. The process line 200 involves the use of a roll 202 of a flexible polyethylene strip 204 wound on a feed reel 206. The strip 204 functions as the blank from which is formed the base element 10 of the probe tip cover 1.

The strip 204 is drawn off the feed reel 206 by film feed rolls 214, 206 located at the end portion of the process line 200. The film feed rolls 214, 216 may be driven by a stepper motor (not shown) and timed with the opening of the mold 100. An idler wheel 208 guides the strip 204 off the feed reel 206 towards a molding station 210. A drag brake 212 may be used on the roll 202 to create desired tension on the strip 204 as it comes off the roll 202.

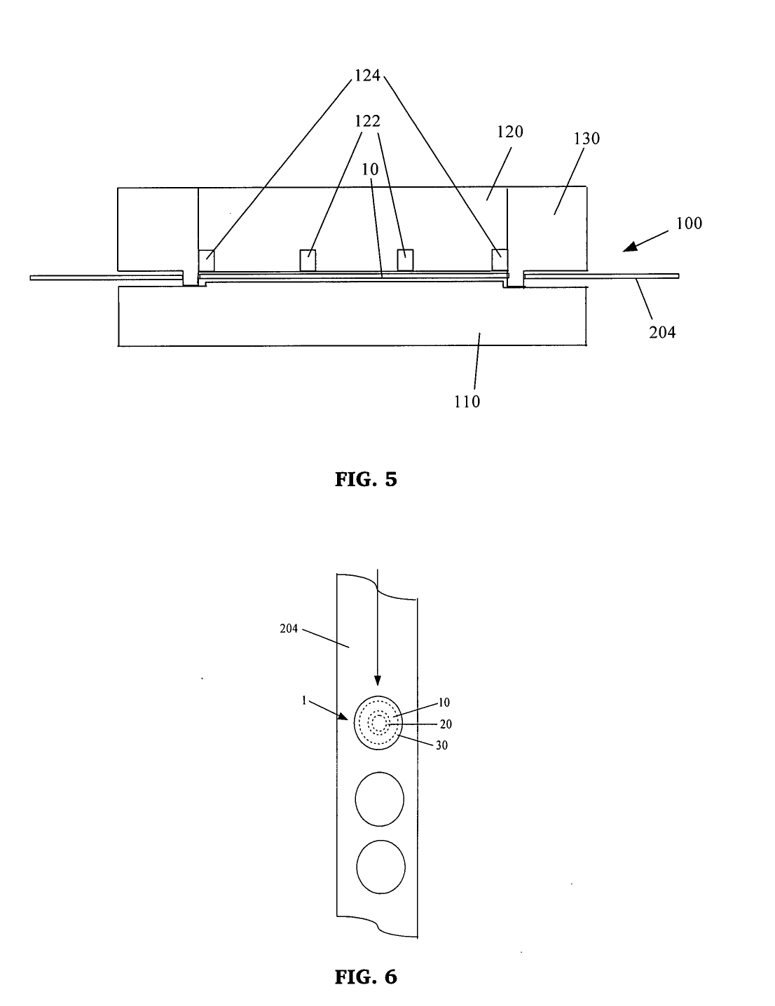

At the molding station 210, the strip 204 passes over the stationary lower mold half 110. At predetermined intervals, the drawing of the strip 204 from the feed reel 206 ceases and the upper mold half 120 and cutting ring 130 are moved into position over the lower mold half 110 with the strip 204 therebetween. As shown in FIG. 5, the continued downward movement of the upper mold half 120 and cutting ring 130 results in trimming of the strip 204 to form the annular base element 10 of the probe cover 1. The annular flange 132 of the cutting ring 130 holds the base element 10 in position after the base element 10 is trimmed from the strip 204. At the same time, molding resin, such as, for example, HDPE, is injected into the first and second annular cavities 122, 124 of the mold 100 through a runner (not shown), to thereby overmold the inner and outer rings 20, 30 onto the base element 10.

FIG. 6 is a partial plan view of the strip 204 after the inner and outer rings 20, have been overmolded onto the base element 10 to form the probe tip cover 1. The circular openings below the probe tip cover 1 show where base elements for previously formed probe tip covers were trimmed from the strip 204. The unused portion of the strip 204 continues through the film feed rolls 214, 216 to scrap.

Now that the preferred embodiments have been shown and described in detail, various modifications and improvements thereon will be readily apparent to those skilled in the art. Accordingly, the spirit and scope of the present invention is to be construed broadly and be limited only by the appended claims, and not by the foregoing specification.

What is claimed is:

1. A method of molding a second part onto a first part to form a molded product, the method comprising:
placing a blank between a first mold half and a second mold half of a mold, where the first mold half includes at least one cavity;
trimming the blank to form the first part; and
injecting molten resin into the at least one cavity of the first mold half to mold the second part onto the first part.

2. The method of claim 1, wherein the blank is a flexible film, and the method further comprises a step of generating tension in the flexible film.

3. The method of claim 2, wherein the molded product is a tympanic thermometer probe tip cover, and the trimming step comprises trimming the flexible film to form a disc-shaped base element of the probe tip cover as the first part.

4. The method of claim 3, wherein the second part comprises inner and outer rings of the probe tip cover.

5. The method of claim 4, wherein the first mold half comprises two cavities that correspond to the inner and outer rings of the probe tip cover.

6. The method of claim 3, wherein the flexible film is made of polyethylene.

7. The method of claim 4, wherein the molten resin is high density polyethylene.

8. The method of claim 4, wherein the molten resin comprises a material selected from the group consisting of polyesters, nylons, urethanes, silicone, polyvinyl chloride, neoprene, thermoplastic rubber, Tyvek® materials, polypropylene and polyethylene-terephthalate

9. A mold for molding a second part onto a first part to form a molded product during a molding operation, comprising:
a first mold half having at least one cavity that receives molten resin to form the second part;
a second mold half; and
a trimming element for trimming the first part during the molding operation.

10. The mold of claim 10, wherein the trimming element is disposed around the first mold half and is slidable relative to the first mold half to trim the first part.
